(19) United States
(12) Patent Application Publication
(10) Pub. No.: US 2004/0212484 A1
(43) Pub. Date: Oct. 28, 2004

(54) Control device and method for automatically adjusting view angle of rearview angle of outside camera in response to output of navigation system

(75) Inventors: Wen-Wei Su, Hsinchu (TW); Kuei-Hung Chen, Taipei (TW); Shun-Hsiang Hsiao, Miaoli (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: EXON SCIENCE INC., Taoyuan (TW)

(21) Appl. No.: 10/845,825

(22) Filed: May 14, 2004

Related U.S. Application Data
(63) Continuation-in-part of application No. 10/047,762, filed on Jan. 15, 2002, now Pat. No. 6,756,888.
Application No. 10/047,762 is a continuation-in-part of application No. 09/946,094, filed on Sep. 4, 2001, now Pat. No. 6,672,728.

(51) Int. Cl. B60Q 1/00

(52) U.S. Cl. 340/435; 348/148

(57) ABSTRACT

A control method for automatically adjusting a view angle of an outside camera of a turning vehicle is disclosed. The method includes steps of receiving an output of a navigation system; determining a turning level of the vehicle according to the output of the navigation system; and triggering the camera to move to an extent corresponding to the turning level of the vehicle. A control device for automatically adjusting a view angle of a camera of a turning vehicle in response to the output of an electronic compass or a global positioning system (GPS) is also disclosed. The control device includes a microprocessor to receive an output of the electronic compass or GPS, determine a turning level of the vehicle according to the output of the navigation system, and trigger the camera to move to an extent corresponding to the turning level of the vehicle

### CROSS REFERENCE TO RELATED PATENT APPLICATION

This patent application is a continuation-in-part (CIP) application of a U.S. patent application Ser. No. 10/047,762 filed Jan. 15, 2002 and now pending, which is a continuation-in-part (CIP) application of a U.S. patent application Ser. No. 09/946,094 filed Sep. 4, 2001 and now issued. The contents of the related patent applications are incorporated herein for reference.

### FIELD OF THE INVENTION

The present invention relates to a control device of an outside camera of a vehicle, and more particular to a control device for automatically adjusting a view angle of the outside camera of a turning vehicle. The present invention also relates to a control method for automatically adjusting a view angle of an outside camera of a turning vehicle in response to an output of a navigation system such as an electronic compass or a global positioning system (GPS). The present invention further relates to a view-angle adjusting system.

### BACKGROUND OF THE INVENTION

When a driver would like to change to another lane or turn to another direction, he will need to realize more about the situation of the adjacent lane to see whether there is any vehicle oncoming. For example, when the vehicle is turning right, it is desirable that the driver clearly sees the right lane. Therefore, it is desired that the driver's view be dynamically adjusted in order to avoid any blind spot.

In addition to rearview mirrors, CCD cameras become more and more popular for the driver to realize the situation outside the vehicle. Referring to FIG. 1, a CCD camera 12 is provided on the rear bumper of the vehicle 10 to pickup the situation behind the vehicle, and the driver can realize rearward information via a display 14 inside the vehicle 10, thereby facilitating the backup operation. The CCD camera, if mounted at proper locations of the vehicle 10, the driver can learn more outside information via the display 12 inside the vehicle 10. For example, when a driver would like to change to another lane or turn to another direction, the disposition of a right-side-oriented camera may help the user to observe the adjacent right lane. Since the view angle of a current vehicular CCD camera is fixed, one camera only seems not to comply with the requirements of dynamic observation. For improving the driving security, it may require several cameras oriented differentially in order to view the surroundings clearly. Such arrangement is cost-inefficient. Further, when different cameras are used sequentially to reveal the outside situation on the same display, the frequent frame-switching of the display may bother the driver.

### SUMMARY OF THE INVENTION

Therefore, the present invention provides a control device and method, which can adjust the view angle of the outside camera automatically while the vehicle is turning.

The present invention further provides a control device and method, which can adjust the view angle of the outside camera dynamically according to the turning angle of the vehicle.

The present invention further provides a view-angle adjusting system to obtain various view angles depending on the turning levels of the vehicle.

A first aspect of the present invention relates to a control method for automatically adjusting a view angle of a camera of a turning vehicle to show a desired view on a display. The control method comprises steps of: receiving an output of a navigation system; determining a turning operation of the vehicle according to the output of the navigation system; triggering the camera to move in response to the turning operation of the vehicle; and showing image picked up by the camera on the display.

Preferably, the control method further comprises a step of determining a turning level of the turning operation, the camera being triggered to move to an extent corresponding to the turning level.

Preferably, a plurality of image frames of the camera are shown on the display during the camera is moving to the extent.

In an embodiment, the navigation system is an electronic compass. The turning level of the vehicle is determined by comparing the output of the electronic compass with a preset value. The receiving, comparing and triggering steps are repeated to dynamically adjust a view angle of the camera of the vehicle.

More preferably, a step of counting a time period is performed, wherein the time period is accumulatively counted when the turning level is kept to be zero, and the time period is counted over whenever the turning level is determined to be non-zero.

In an embodiment, the output of the electronic compass replaces for the preset value to serve as a new preset value, and the camera is triggered to be restored to its initial position when the counted time period exceeds a predetermined value.

In an embodiment, the output of the electronic compass is indicative of one of sixteen direction zones, the preset value is indicative of one of the sixteen direction zones, and the turning level is determined to be zero when the output of the electronic compass and the preset value indicate the same direction zone.

In an embodiment, the turning level correlates to an angle between the direction zones indicated by the output of the electronic compass and the preset value.

In an embodiment, the navigation system is a global positioning system (GPS). The turning level correlates to a predetermined turning angle under the guidance of the GPS.

Preferably, the control method further comprises a step of triggering the camera to be restored to its initial position when the GPS indicates the completion of a turning operation by the predetermined turning angle.

The camera, for example, can be a charge-coupled device (CCD) camera.

A second aspect of the present invention relates to a control device for automatically adjusting a view angle of a monitoring device of a turning vehicle. The control device comprises a microprocessor which repetitively receives an output of a navigation system, determines a turning operation of the vehicle according to the output of the navigation system, and triggers the camera to move in response to the turning operation of the vehicle and transmit the captured image to a display while the camera is moving.

A third aspect of the present invention relates to a view-range adjusting system for rendering various view ranges in response to a turning operation of a vehicle. The view-range adjusting system comprises a vehicular camera for capturing environmental image; a display receiving and displaying the environmental image for the driver's reference; and a control device controlling the environmental image to be displayed in various view ranges when the vehicle turns differentially by repetitively receiving an output of a navigation system, determining the turning operation of the vehicle according to the output of the navigation system, and triggering the vehicular camera to capture the environmental image in a desired view range in response to the turning operation.

Preferably, the control device further determines a turning level of the turning operation, and the desired view range of the environmental image captured by the vehicular camera depends on the turning level.

For example, the navigation system can be a global positioning system (GPS) or an electronic compass.

In an embodiment, the vehicular camera is rotated to capture the environmental image in various view ranges.

In an embodiment, the vehicular camera is zoomed in/out to capture the environmental image in various view ranges.

For example, the camera can be disposed on the rear bumper of the vehicle for also facilitating the backup operation of the vehicle.

In an embodiment, the display is disposed at a console beside the driver's seat. Alternatively, the display can be integrated into an interior rearview mirror beside the driver's seat. In another example, the display can be a head-up display disposed at the front windscreen.

### BRIEF DESCRIPTION OF THE DRAWINGS

The present invention may best be understood through the following description with reference to the accompanying drawings, in which:

FIG. 1 is a schematic diagram showing the disposition of CCD cameras in a conventional vehicle;

FIG. 2 is a schematic circuit diagram showing a preferred embodiment of a control device according to the present invention;

FIG. 3 is a schematic diagram showing a point schedule of an electronic compass to be used with the present invention;

FIG. 4 is a circuit functional block diagram schematically showing a preferred embodiment of a view-range adjusting system for use with an electronic compass according to the present invention; and

FIG. 5 is a schematic diagram exemplifying a route of the vehicle suggested by the GPS to travel from a start point A to a destination H;

FIG. 6 is a circuit functional block diagram schematically showing a preferred embodiment of a view-range adjusting system for use with a global positioning system according to the present invention; and

FIG. 7 is a schematic diagram showing the transmission of signals between a control device according to the present invention and cameras to be manipulated via a CAN-bus system.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

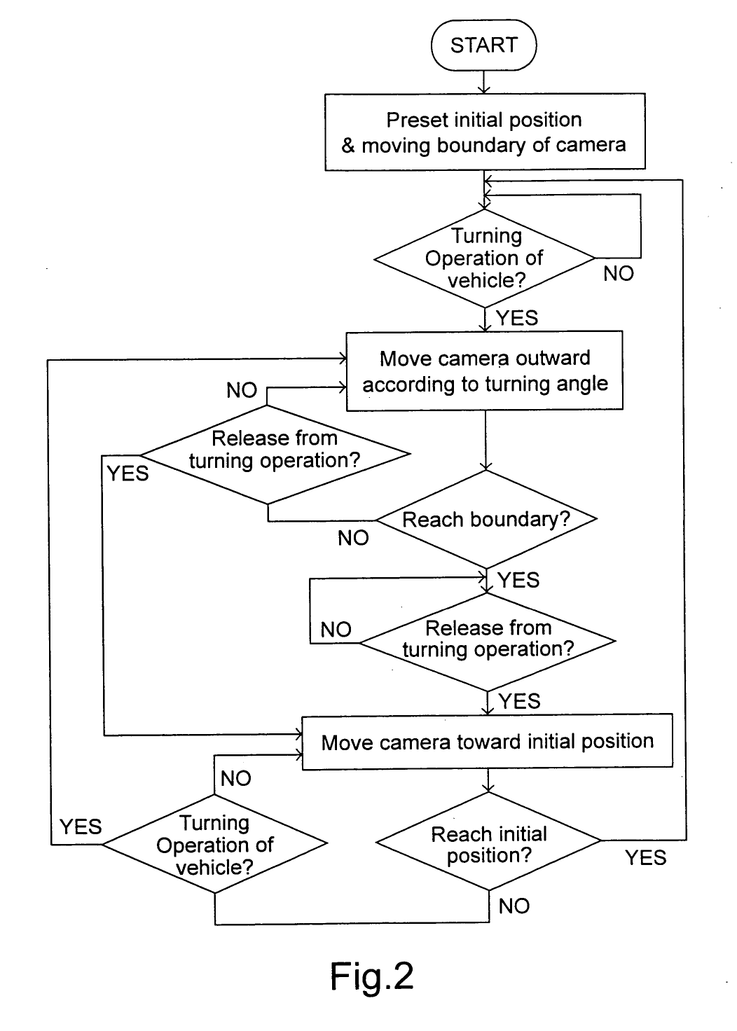

In order to allow the view range of the outside camera to be automatically and dynamically adjusted while driving, a method is illustrated herein with reference to a flowchart of FIG. 2 for achieving that purpose. Herein, the term “outside camera” does not particularly confine the position of the camera outside the vehicle, but means to capture environmental images outside the vehicle. It is to be noted that the automatic view-angle adjusting function can be designed as a basic response of the vehicle. Alternatively, the function can be enabled by pressing a key or a button. It is also understood the flowchart of FIG. 2 is for illustrating one of the cameras, and a similar operation may be applied to the other camera if more than one camera are installed on the vehicle. The camera used herein can be any suitable type of camera, e.g. a charge-coupled device (CCD) camera.

First of all, an initial position of each camera is preset before driving. Then, for example, the driver is turning the vehicle right. Meanwhile, the turning angle of the vehicle is detected, and the vehicular camera rotates rightwards dynamically in response to the turning angle of the vehicle in order to change the view angle at the right side. The rightward rotation of the camera is preferably confined within a proper boundary. In other words, when the camera reaches the moving boundary, the camera will not rotate further even if the vehicle still turns. On the other hand, no matter if the camera reaches the moving boundary or not, the camera moves toward the initial position upon the vehicle returns to the forward direction. Likewise, during the trip of the camera back to the initial position, no matter if the camera reaches the initial position or not, the camera is rotated rightward or leftward again in response to the turning operation of the vehicle. The turning operation of the vehicle, for example, can be inferred from the output of an electronic compass or a global positioning system (GPS). Embodiments of the control device for executing the present method are illustrated hereinafter.

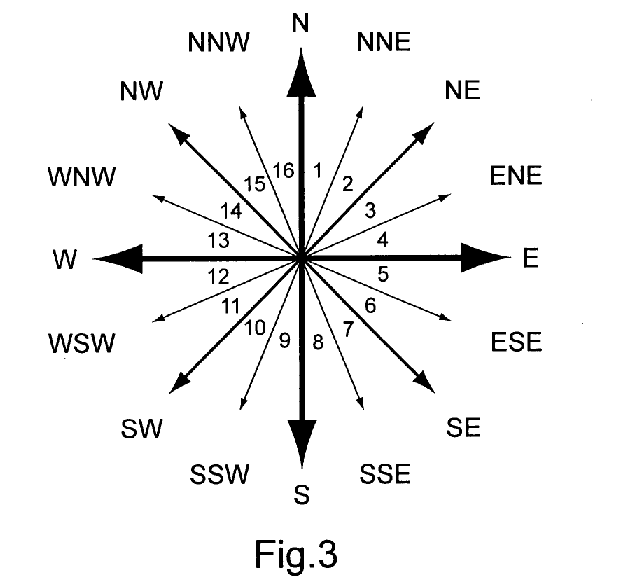

In an embodiment of the present invention, the turning operation of the vehicle is determined by detecting the output of a vehicular electronic compass. As known, an electronic compass works in response to the magnetic field of the earth, thereby identifying the travel direction of the vehicle. The operational principle of the electronic compass is understood by those skilled in the art, and will not be described here. The 360-degree circle the electronic compass is scheduled as a predetermined number of direction zones, e.g. 16 zones 1˜16, each of which lies between two of the points N, NNE, NE, ENE, E, ESE, SE, SSE, S, SSW, SW, WSW, W, WNW, NW and NNW, as shown in FIG. 3. When the compass needle crosses a point line between two direction zones, it is determined that the vehicle makes a turn. For example, when the vehicle is heading the direction zone 1 and remains the direction for more than a predetermined time period, e.g. 2 seconds, the direction zone 1 will be set as a reference origin. Afterwards, the vehicle turns right to the direction zone 2. Meanwhile, the camera is actuated to rotate rightwards to an extent corresponding to the turning operation of one direction zone. If the vehicle further turns right to the direction zone 3, the camera will be further rotated rightwards to an extent corresponding to the turning operation of two direction zones. Further rotating operation of the camera will be performed if the vehicle turns to a further direction zone, unless the preset moving boundary is reached. On the other hand, if the vehicle remains in the direction zone 2 for more than the predetermined time period after turning to the direction zone 2, the direction zone 2 will be set as the new reference origin, and the camera will return to the initial position. Then the turning operation of the vehicle to the direction zone 3 makes the rotation of the camera reach an extent corresponding to the turning operation across one direction zone. When the vehicle turns left soon from the direction zone 3 to the direction zone 16 through the reference origin, i.e. the direction zone 2, the camera will return to the initial position, and then rotate leftwards to an extent corresponding to a turning operation across two direction zones 1 & 16. By this way, the view angle of the camera can be automatically and dynamically adjusted in response to the turning angle of the vehicle.

If more than one camera are used in the view-range adjusting system, the view angle of the camera at the left side can be designed to stay unchanged when the camera at the right side rotates. Alternatively, the camera at the left side can be designed to rotate synchronously in the same direction when the camera at the right side rotates rightwards.

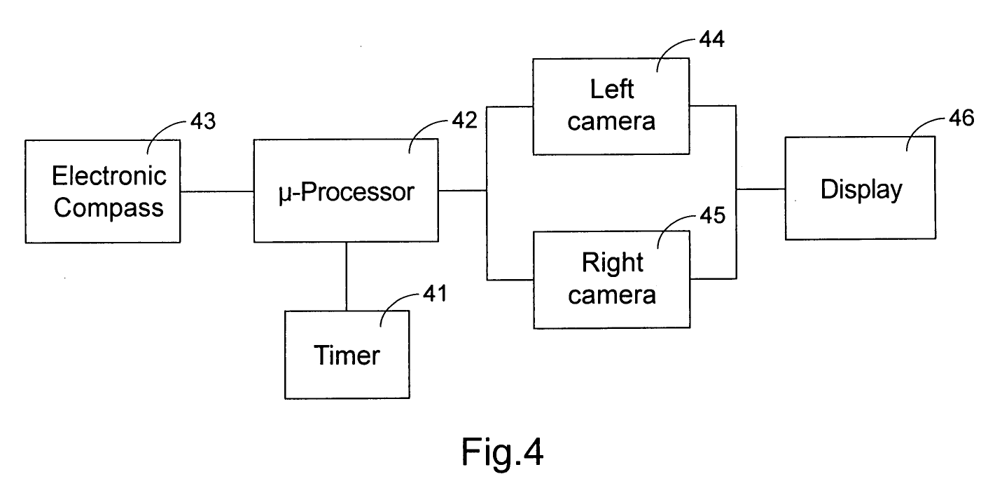

In order to achieve the purpose of automatically, and preferred dynamically, adjusting the view angle of the camera in response to a turning operation of the vehicle, as mentioned above, a control device is used to coordinate the camera and the electronic compass. FIG. 4 is a circuit functional block diagram schematically showing a preferred embodiment of a view-range adjusting system for use with an electronic compass according to the present invention. The control device includes a timer 41 and a microprocessor 42 or an application specific integrated circuit (ASIC). The output of the electronic compass 43 representing a heading direction zone is transmitted to the microprocessor 42 to be compared with a preset value representing an initial direction zone, and the timer 41 starts to count at the same time. When determining a change in direction zones by a first level within a predetermined period, e.g. 2 seconds, the microprocessor 42 outputs a control signal to rotate one or both of the left and right cameras 44 and 45 to a degree corresponding to the first level of direction change in a manner as mentioned above. Accordingly, the driver can view the outside via the display 46. It is understood that the timing operation can also be performed by the microprocessor 42 itself in a form of software so as to omit the timer 41. If the heading direction zone of the vehicle keeps unchanged during that predetermined period, the preset value will be replaced by another one representing the heading direction zone, and the counting operation of the timer 41 will start over. Meanwhile, the cameras are restored to their initial positions. The changing level of the direction zones is now based on the newly set direction zone.

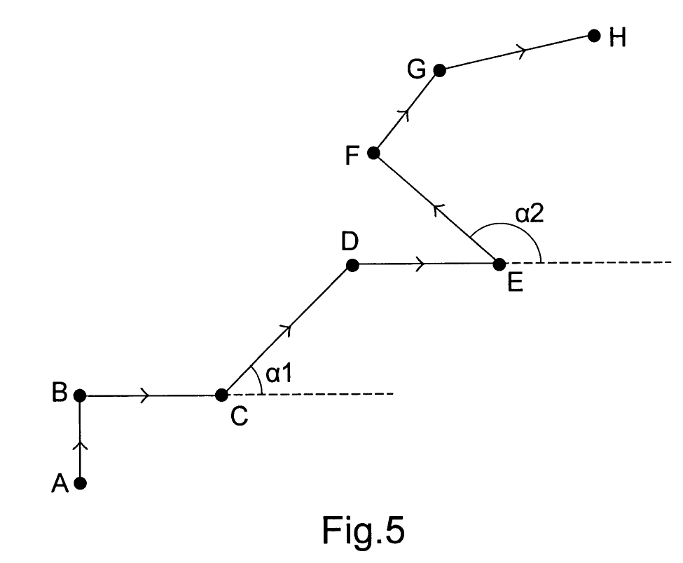

In another embodiment of the present invention, the turning operation of the vehicle is determined by detecting the output of a global positioning system (GPS). As known, the GPS directs the moving path of a vehicle by communicating with different satellites orbiting the earth via radio waves. The operational principle of the GPS is understood by those skilled in the art, and will not be describe herein. Please refer to FIG. 5 which is a schematic diagram exemplifying a route of the vehicle suggested by the GPS to travel from a start point A to a destination H. The route includes a substantially straight line from A to B, a right turn and then a straight line from B to C, a left turn and then a straight line from C to D, a right turn and a straight line from D to E, a left turn and then a straight line from E to F, a right turn and then a straight line from F to G, and another right turn and a straight line from G to H. In other words, it is predetermined that the vehicle will make four right turns and two left turns to reach the destination H, and the GPS acquires the turning operations of the vehicle in advance. Whenever the vehicle gets to a position required to make a right turn by the GPS, i.e. the position B, D, F or G, the single camera or the camera at the right side automatically rotates rightwards to view the right side. Afterwards, when the vehicle enters a straight line after a right turn operation, the camera will return the initial position. Alternatively, the camera may be restored to its initial position by counting a predetermined period, e.g. 2 seconds. Likewise, whenever the vehicle gets to a position required to make a left turn by the GPS, i.e. the position C or E, the single camera or the camera at the left side automatically rotates leftwards to view the left side.

In the above embodiment, it is to be noted that although the vehicle turns left at both of the positions C and E, the turning angles at the two positions are different. It is clear from FIG. 5 that the turning angle α2 at the position E is larger than the turning angle α1 at the position C. Therefore, the camera at the position E will rotate leftwards by an angle larger than the leftward rotating angle of the camera at the position C. The camera at the right side, if any, can be designed or selected to keep unmoved or rotate along with the left-side camera when the camera at the left side rotates in response to a left-turn operation of the vehicle.

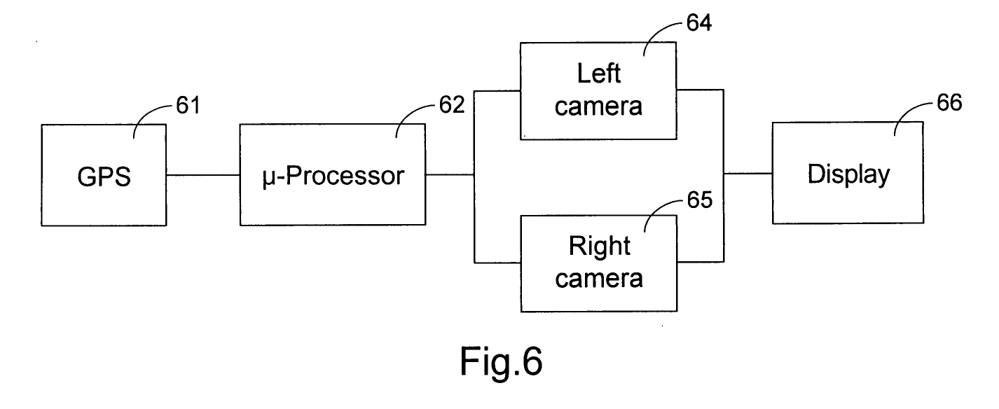

In order to achieve the purpose of automatically, and preferred dynamically, adjusting the view angle of the camera in response to a turning operation of the vehicle, as mentioned above, a control device is used to coordinate the camera and the GPS. FIG. 6 is a circuit functional block diagram schematically showing a preferred embodiment of a view-range adjusting system for use with a global positioning system (GPS) according to the present invention. The output of the GPS is transmitted to the microprocessor 62. In response to the output of the GPS 61 indicative of a turning operation, the microprocessor 62 outputs a control signal to rotate one or both of the left and right cameras 64 and 65 to a degree corresponding to the first level of direction change in a manner as mentioned above. After the vehicle completes the turning operation, the cameras are restored to their initial position.

The control device according to the present invention can be integrated into the computer system of the vehicle, and receives and transmits signals via a traditional communication network system or a controller area network bus (CAN-bus) system of a vehicle. Alternatively, it can be a control module added to an existent computer system of the vehicle especially via a CAN-bus system. A CAN-bus system is a communication standard for vehicles, which has been established since 1990 to communicate local computers with one another. Due to the arrangement of local computers or control modules, the numerous and complicated cables of various equipment of the vehicle are localized and simplified, and all the signals are transmitted among computers or control modules via the CAN-bus system. Consequently, the overall length and weight of the cables are significantly reduced.

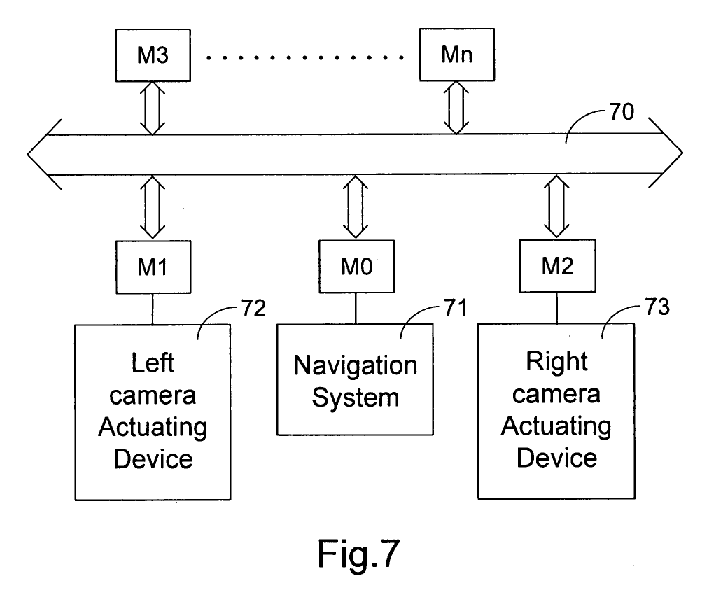

FIG. 7 schematically shows the transmission of signals between a control device according to the present invention and outside cameras to be manipulated via a CAN-bus system. The present control module M0 is electrically connected between the CAN bus 70 and a navigation system 71. The control module MO receives the output of a navigation system 71 such as an electronic compass or GPS, and transmits out a digital encoding signal to the CAN bus 70 to inform of a turning operation of the vehicle. Meanwhile, all the local computers or control modules M1 . . . Mn can acquire the information via the CAN bus. The digital encoding signal includes an ID code and a command code. The ID code directs to one or both of the control modules M1 and M2, so it is only the relevant control module(s) will respond to the digital encoding signal. The command code corresponds to a message for triggering the relevant camera actuating device(s) 72 and/or 73, e.g. motor(s), to rotate the left and/or right camera(s).

In addition to the rotation of the camera, the view range can also be adjusted via a zooming in/out operation of the camera. For example, when the situation of the adjacent lane is to be monitored, the camera can be zoomed out to enlarge the view range. Alternatively, if more than one camera are used, the camera at the right side is zoomed out to enlarge the view range at the right side as so as to show the situation of the right lane.

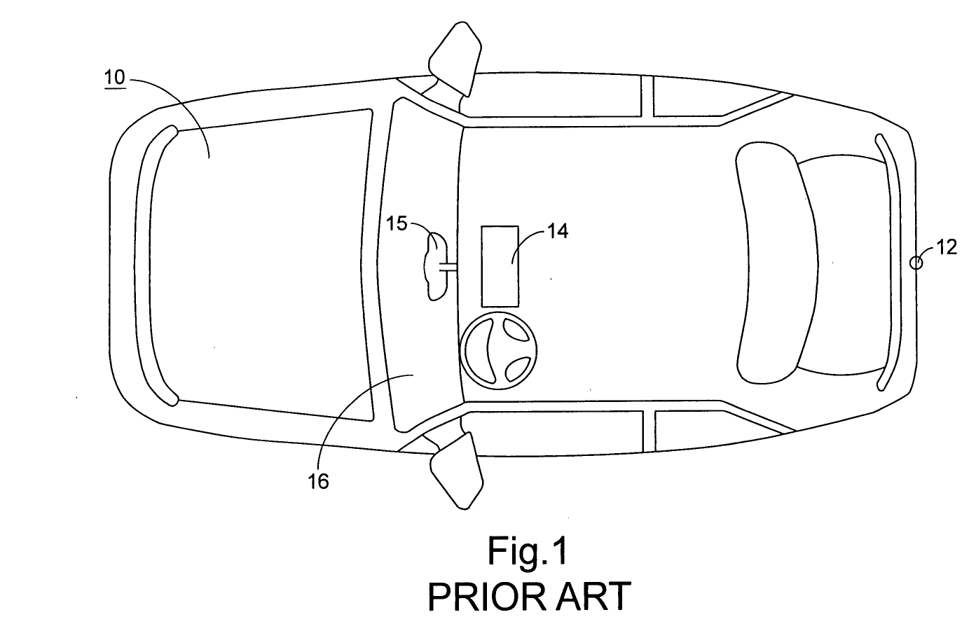

It is to be noted that in addition to the rear bumper, the camera(s) can be disposed at any other suitable positions where the right lane or the left lane is visible. Further, the image captured by the camera(s) is transmitted to a display to be observed by the driver. The display, in addition to the conventional liquid crystal display (LCD) arranged at the console beside the driver's seat, can also be a display integrated into the interior rearview mirror 15 or a head-up display disposed on the front windscreen 16 as shown in FIG. 1.

According to the present invention, the conventional used CCD cameras or additional arranged cameras are used to provide outside information for the driver upon vehicle's turning. By having the cameras rotating with the vehicle's turning, a reduced number of cameras can be used to have an enlarged range of view so as to facilitate the turning operations in a safe manner.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control method for automatically adjusting a view range of a camera of a turning vehicle to show a desired view on a display, comprising steps of:
receiving an output of a navigation system;
determining a turning operation of said vehicle according to said output of said navigation system;
triggering said camera to move in response to said turning operation of said vehicle; and
showing image picked up by said camera on said display.

2. The control method according to claim 1 further comprising a step of determining a turning level of said turning operation, said camera being triggered to move to an extent corresponding to said turning level.

3. The control method according to claim 2 wherein a plurality of image frames of said camera are shown on said display during said camera is moving to said extent.

4. The control method according to claim 2 wherein said navigation system is an electronic compass.

5. The control method according to claim 4 wherein said turning level of said vehicle is determined by comparing said output of said electronic compass with a preset value.

6. The control method according to claim 5 wherein said receiving, comparing and triggering steps are repeated to dynamically adjust a view angle of said camera of said vehicle.

7. The control method according to claim 6 further comprising a step of counting a time period, wherein said time period is accumulatively counted when said turning level is kept to be zero, and said time period is counted over whenever said turning level is determined to be non-zero.

8. The control method according to claim 7 wherein said output of said electronic compass replaces for said preset value to serve as a new preset value, and said camera is triggered to be restored to its initial position when said counted time period exceeds a predetermined value.

9. The control method according to claim 5 wherein said output of said electronic compass is indicative of one of sixteen direction zones, said preset value is indicative of one of said sixteen direction zones, and said turning level is determined to be zero when said output of said electronic compass and said preset value indicate the same direction zone.

10. The control method according to claim 9 wherein said turning level correlates to an angle between said direction zones indicated by said output of said electronic compass and said preset value.

11. The control method according to claim 2 wherein said navigation system is a global positioning system (GPS).

12. The control method according to claim 11 wherein said turning level correlates to a predetermined turning angle under the guidance of said GPS.

13. The control method according to claim 12 further comprising a step of triggering said camera to be restored to its initial position when said GPS indicates the completion of a turning operation by said predetermined turning angle.

14. A control device for automatically adjusting a view range of a camera of a turning vehicle, comprising a microprocessor which repetitively receives an output of a navigation system, determines a turning operation of said vehicle according to said output of said navigation system, and triggers said camera to move in response to said turning operation of said vehicle and transmit the captured image to a display while said camera is moving.

15. The control device according to claim 14 wherein said microprocessor further determines a turning level of said turning operation, and said camera is triggered to move to an extent corresponding to said turning level.

16. The control device according to claim 15 wherein said navigation system is a global positioning system (GPS).

17. The control device according to claim 15 wherein said navigation system is an electronic compass.

18. The control device according to claim 17 wherein said microprocessor further performs a timing operation to accumulatively count a time period when said turning level is zero, and said time period is counted over when said turning level is non-zero.

19. The control device according to claim 17 further comprising a timer electrically connected to said microprocessor for counting a time period, wherein said time period is accumulatively counted whenever said microprocessor determines said turning level is zero, and said time period is counted over whenever said microprocessor determines said turning level is non-zero.

20. The control device according to claim 19 wherein said microprocessor has said output of said electronic compass replace for said preset value to serve as a new preset value, and triggers said camera to be restored to its initial position when said counted time period exceeds a predetermined value.

21. A view-range adjusting system for rendering various view ranges in response to a turning operation of a vehicle, comprising:
a vehicular camera for capturing environmental image;
a display receiving and displaying said environmental image for the driver's reference; and
a control device controlling said environmental image to be displayed in various view ranges when said vehicle turns differentially by repetitively receiving an output of a navigation system, determining said turning operation of said vehicle according to said output of said navigation system, and triggering said vehicular camera to capture said environmental image in a desired view range in response to said turning operation.

22. The view-range adjusting system according to claim 21 wherein
said control device further determines a turning level of said turning operation, and said desired view range of said environmental image captured by said vehicular camera depends on said turning level.

23. The view-range adjusting system according to claim 21 wherein
said navigation system is a global positioning system (GPS).

24. The view-range adjusting system according to claim 21 wherein
said navigation system is an electronic compass.

25. The view-range adjusting system according to claim 21 wherein
said vehicular camera is rotated to capture said environmental image in various view ranges.

26. The view-range adjusting system according to claim 21 wherein
said vehicular camera is zoomed in/out to capture said environmental image in various view ranges.

27. The view-range adjusting system according to claim 21 wherein
said camera is disposed on the rear bumper of said vehicle.

28. The view-range adjusting system according to claim 21 wherein
said display is disposed at a console beside the driver's seat.

29. The view-range adjusting system according to claim 21 wherein
said display is integrated into an interior rearview mirror beside the driver's seat.

30. The view-range adjusting system according to claim 21 wherein
said display is a head-up display disposed at the front windscreen.
